(19) United States
(12) Patent Application Publication
(10) Pub. No.: US 2009/0207314 A1
(43) Pub. Date: Aug. 20, 2009

(54) METHOD AND SYSTEM FOR MOTION VECTOR ESTIMATION USING A PIVOTAL PIXEL SEARCH

(76) Inventors: Brian Heng, Irvine, CA (US); Xuemin Chen, San Diego, CA (US); Frederick G. Walls, Norristown, PA (US)

Correspondence Address: MCANDREWS HELD & MALLOY, LTD, 500 WEST MADISON STREET, SUITE 3400, CHICAGO, IL, 60661, US

(21) Appl. No.: 12/031,461

(22) Filed: Feb. 14, 2008

(51) Int. Cl. H04N 5/14

(52) U.S. Cl. 348/699; 348/E05.062

(57) ABSTRACT

Aspects of a method and system for motion vector estimation using a pivotal pixel search are presented. Aspects of the system may include an image interpolation system that enables selection of an interpolated picture element neighborhood within an interpolated image frame. The image interpolation system may enable selection of one of a plurality of computed candidate motion vectors based on the location of the interpolated picture element neighborhood within the interpolated image frame. The image interpolation system may enable generation of picture element values within the selected interpolated picture element neighborhood based on at least the selected one of the plurality of computed candidate motion vectors.

### CROSS-REFERENCE TO RELATED APPLICATIONS/INCORPORATION BY REFERENCE

Not Applicable.

### FIELD OF THE INVENTION

Certain embodiments of the invention relate to video communication and processing. More specifically, certain embodiments of the invention relate to a method and system for motion vector estimation using a pivotal pixel search.

### BACKGROUND OF THE INVENTION

In many video processing applications, in which moving objects may be displayed in a sequence of image frames, it may be useful to have knowledge of the motion which occurs from frame to frame. Examples of such applications include, frame rate conversion, deinterlacing, noise reduction, and cross-chroma reduction. In a typical method for frame rate conversion, for example one that enables doubling of the frame rate of a video sequence, each image frame may be repeated twice. By taking this information into account, one can perform adaptive processing that adapts to and compensates for the motion in the scene.

There have been many methods proposed for modeling the motion in a scene. One such method is a translational block-based model. In this model, the original frame is broken into small blocks, and the motion between frames is modeled in terms of translational shifts of these blocks. Each block is assigned a two-dimensional (horizontal/vertical) motion vector (MV) that describes the translational shift assigned to each block.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for motion vector estimation using a pivotal pixel search, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram that illustrates an exemplary method for motion vector estimation using a pivotal pixel search, in accordance with an embodiment of the invention.

FIG. 2 is a block diagram of an exemplary system for generating interpolated image frames, in accordance with an embodiment of the invention.

FIG. 3 is an exemplary diagram of a system for hierarchical motion estimation with multi-layer sub-pixel accuracy, which may be utilized in connection with an embodiment of the invention.

FIG. 4A is a diagram that illustrates exemplary level 2 motion estimation, which may be utilized in connection with an embodiment of the invention.

FIG. 4B is a diagram that illustrates exemplary level 1 motion estimation, which may be utilized in connection with an embodiment of the invention.

FIG. 4C is a diagram that illustrates exemplary level 0 motion estimation, which may be utilized in connection with an embodiment of the invention.

FIG. 5 is a flowchart illustrating exemplary steps for motion vector estimation using a pivotal pixel search, in accordance with an embodiment of the invention.

### DETAILED DESCRIPTION OF THE INVENTION

Certain embodiments of the invention relate to a method and system for motion vector estimation using a pivotal pixel search. Various embodiments of the invention comprise a method and system in which an interpolated image frame may be generated by selecting a neighborhood of picture element (pixel) block locations within the interpolated image frame. For each selected pixel block, a plurality of candidate motion vectors may be selected. Within each selected pixel block, each of the plurality of candidate motion vectors may be evaluated based on one or more selection criteria. One of the candidate motion vectors may be selected based on the one or more selection criteria. Based on the selected motion vector, corresponding pixel block locations may be determined within a preceding image frame and a current image frame, wherein the interpolated image frame may be temporally located between the preceding image frame and the current image frame. Based on the determined pixel block locations within the preceding and current image frames a corresponding pixel block may be generated within the interpolated image frame.

In various embodiments of the invention, motion vectors may be computed utilizing various methods and/or techniques. While one or more exemplary methods for motion vector computation may be described, implied and/or suggested below, for the purposes of this application various embodiments of the invention are not limited to any specific method for motion vector computation.

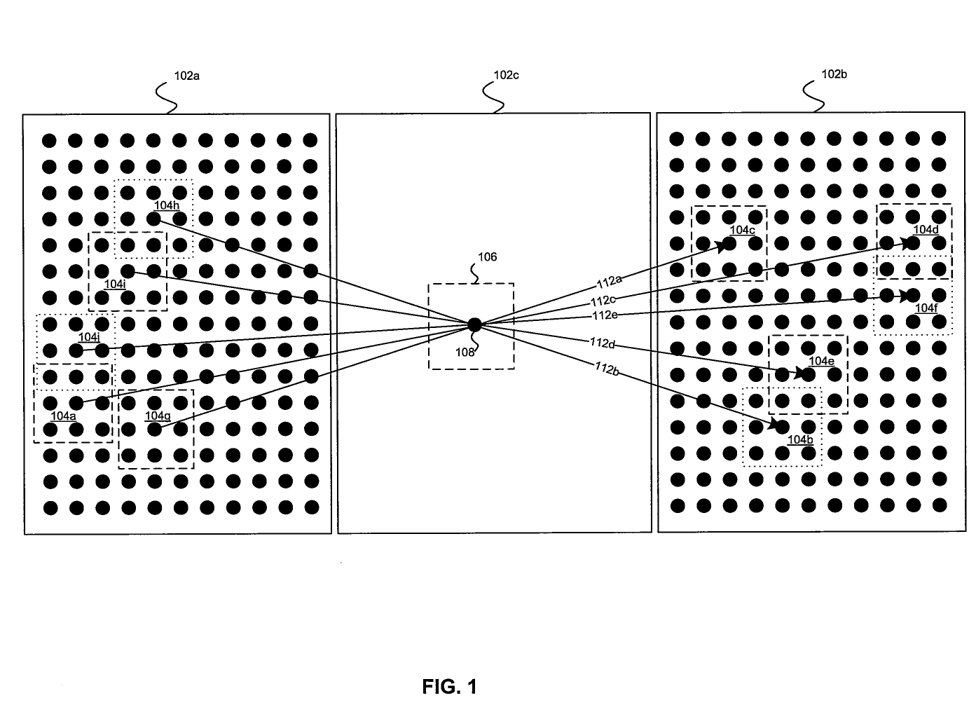

FIG. 1 is a block diagram that illustrates an exemplary method for motion vector estimation using a pivotal pixel search, in accordance with an embodiment of the invention. Referring to FIG. 1, a plurality of candidate motion vectors 112a, 112b, 112c, 112d and 112e may be computed based on a plurality of preceding image processing blocks 104a, 104g, 104h, 104i and 104j within a preceding image frame 102a, and a corresponding plurality of current image processing blocks 104b, 104c, 104d, 104e and 104f. Each of the image processing blocks 104a, 104b, 104c, 104d, 104e, 104f, 104g, 104h, 104i and 104j may comprise a P×Q pixel neighborhood. As shown in the exemplary FIG. 1, each of the image processing blocks 104a, 104b, 104c, 104d, 104e, 104f, 104g, 104h, 104i and 104j comprise a 3×3 pixel neighborhood. The candidate motion vectors 112a, 112b, 112c, 112d and 112e may be computed utilizing various image processing methods.

In an exemplary embodiment of the invention, the candidate motion vector 112a may represent a motion vector computed based on the preceding image processing block 104g and the current image processing block 104c within the current image frame 102b. A correlation error value, σ₁₁₂ₐ, may be computed based on a correlation computation between image processing blocks 104g and 104c. The candidate motion vector 112b may represent a motion vector computed based on the preceding image processing block 104h and the current image processing block 104b. A correlation error value, σ_{112b}, may be computed based on a correlation computation between image processing blocks 104h and 104b. The candidate motion vector 112c may represent a motion vector computed based on the preceding image processing block 104a and the current image processing block 104d. A correlation error value, 112c, may be computed based on a correlation computation between image processing blocks 104h and 104b. The candidate motion vector 112d may represent a motion vector computed based on the preceding image processing block 104i and the current image processing block 104e. A correlation error value, σ_{112d}, may be computed based on a correlation computation between image processing blocks 104i and 104e. The candidate motion vector 112e may represent a motion vector computed based on the preceding image processing block 104j and the current image processing block 104f. A correlation error value, σ₁₁₂ₑ, may be computed based on a correlation computation between image processing blocks 104j and 104f.

An interpolated image processing block 106 may be selected within an interpolated image frame 102c. The interpolated image frame 102c may be temporally located between the preceding image frame 102a and the current image frame 102b. The candidate motion vectors 112a, 112b, 112c, 112d and 112e may comprise a portion of selected motion vectors that intersect in the vicinity of a pixel location 108 within the interpolated image processing block 106. The pixel location 108 may be referred to as a pivot pixel. The candidate motion vectors 112a, 112b, 112c, 112d and 112e may be evaluated based on one or more selection criteria for the selected interpolated image processing block 106. In an exemplary embodiment of the invention, the correlation error values σ₁₁₂ₐ, σ_{112b}, (σ₁₁₂c, σ_{112d} and σ₁₁₂ₑ may be compared. A minimum correlation error value may be determined. A motion vector may be selected from the plurality of candidate motion vectors based on the minimum correlation error value. In the exemplary diagram shown in FIG. 1, σ_{112c} may represent the minimum correlation error value, which corresponds to motion vector 112c. Motion vector 112c may be the selected motion vector in the interpolated image processing block 106.

Based on the selected motion vector 112c, the pixel values within in the interpolated image processing block 106 may be computed based on the pixel values within the preceding and current image processing blocks, which correspond to the selected motion vector 112c. In the exemplary diagram shown in FIG. 1, the selected motion vector 112c corresponds to the preceding image processing block 104a and the current image processing block 104d. In various embodiments of the invention, pixel values within the interpolated image processing block 106 may be computed based on the pixel values within the preceding image processing block 104a and the current image processing block 104d. In an exemplary embodiment of the invention, the pixel values within the interpolated image processing block 106 may be determined based on a correlation computation with the pixel values within the preceding image processing block 104a and/or the current image processing block 104d.

In some conventional image processing systems, a candidate motion vector may be selected and a location for the interpolated image processing block determined based on the selected motion vector. One potential shortcoming with this approach is that when a set of interpolated image processing blocks is generated for the interpolated image frame, some of the interpolated image processing blocks may overlap. For example, some of the pixel locations within the interpolated image frame that are located within a given P×Q pixel neighborhood of a given interpolated image processing block may also be located within at least one other P×Q pixel neighborhood of at least one other interpolated image processing block. Furthermore, some of the pixel locations within the interpolated image frame may not be located within any of the interpolated image processing blocks. These pixel locates may be referred to as “holes” in the interpolated image frame.

In some conventional image processing systems, the location of an image processing block within the interpolated image frame may determined based on the location of the preceding image processing block within the preceding image frame, or based on the location of the current image processing block within the current image frame. One potential shortcoming with this approach is that a video sequence comprising the input video frames and interpolated image frames may present a pattern of misalignment in motion from one frame to the next.

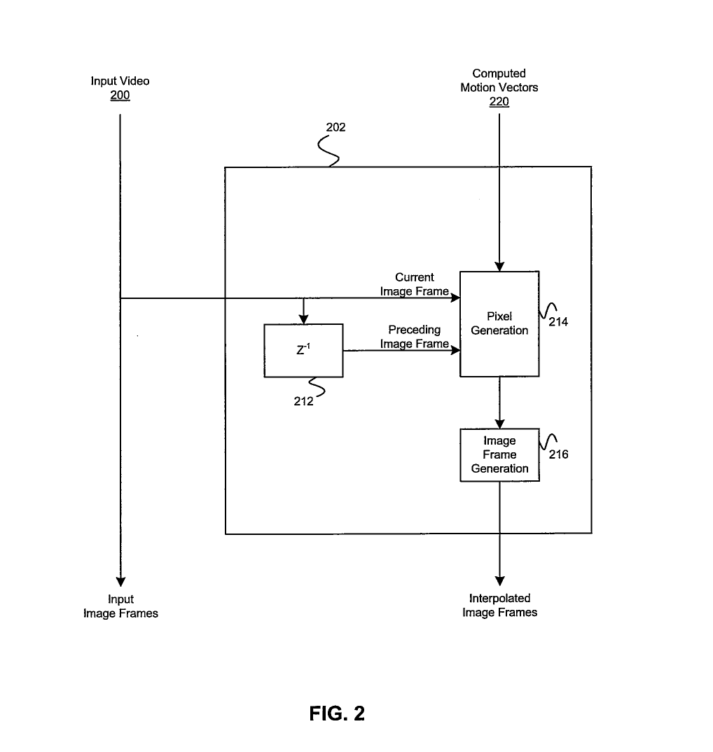

FIG. 2 is a block diagram of an exemplary system for generating interpolated image frames, in accordance with an embodiment of the invention. Referring to FIG. 2, there is shown an image interpolation system 202. The image interpolation system 202 may comprise suitable logic, circuitry and/or code that may enable reception of input video 200 and computed motion vectors 220. The input video 200 may comprise a sequence of image frames. Each image frame may be represented as a M×N pixel block, where M represents the number of lines in the image frame and N represents the number of pixels within each line. The computed motion vectors may comprise a plurality of candidate motion vectors.

The image interpolation system 202 may comprise a delay block 212, a pixel generation block 214 and an image frame generation block 216. The delay block 212 may receive input video 200 and output a time delayed version of the input video. In an exemplary embodiment of the invention, the delay block 212 may insert a one image frame time delay between the received input video 200 and the output. The delay block 212 may receive one or more current image frames and output a one image frame time delayed version of the input current image frames. The time delayed version of the input current image frames may be referred to as preceding image frames.

The pixel generation block 214 may comprise suitable logic, circuitry and/or code that may enable reception of one or more current image frames, one or more preceding image frames and a plurality of candidate motion vectors 220 as input. Based on these inputs, the pixel generation block 214 may enable generation of interpolated image processing blocks. In various embodiments of the invention, the pixel generation block 214 may select a location of the interpolated image processing block within an interpolated image frame. In an exemplary embodiment of the invention, the pixel generation block 214 may select a candidate motion vector based on the selected location for the interpolated image processing block. In various embodiments of the invention, this method may be referred to as a pivot pixel motion vector search method.

The pixel generation block 214 may comprise suitable logic, circuitry and/or code that may enable selection of a preceding image processing block within the preceding image frame and a current image processing block within the current image frame based on the selected motion vector. The pixel generation block 214 may generate pixel values within the interpolated image processing block based on the corresponding pixel values within the selected preceding and current image frames.

The image frame generation block 216 may comprise suitable logic, circuitry and/or code that may enable generation of interpolated image frames based on received interpolated image processing blocks. In an exemplary embodiment of the invention, the image frame generation block 216 may receive interpolated image processing blocks generated by the pixel generation block 214. The image frame generation block 216 may determine whether a sequence of received interpolated image processing blocks are contained within the same interpolated image frame. The image frame generation block 216 may determine the location of each received interpolated image processing block within an interpolated image frame. Upon assembling the group of interpolated image processing blocks associated with a given interpolated image frame the image frame generation block 216 may output a completed interpolated image frame.

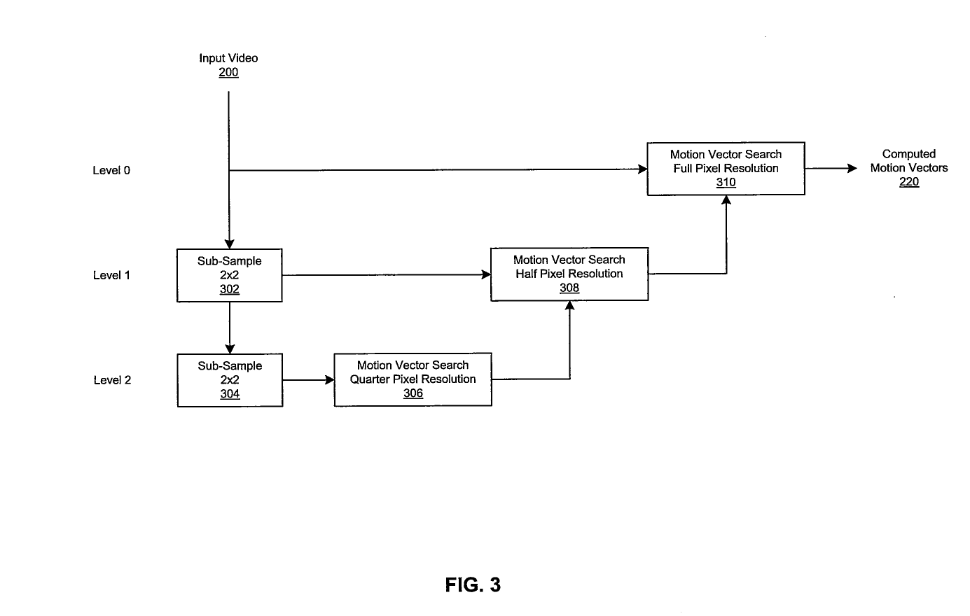

FIG. 3 is an exemplary diagram of a system for hierarchical motion estimation with multi-layer sub-pixel accuracy, which may be utilized in connection with an embodiment of the invention. The hierarchy shown in FIG. 3 comprises a level 0, level 1 and level 2. Each of the levels represents a distinct level within the motion vector computation hierarchy. Referring to FIG. 3, there is shown input video 200, sub-sample blocks 302 and 304, a motion vector search at quarter pixel resolution (quarter pixel) block 306, a motion vector search at half pixel resolution (half pixel) block 308 and a motion vector search at full pixel resolution (full pixel) block 310.

The input video 200 may comprise a sequence of image frames. Each image frame may be represented as an M×N pixel block, where M represents the number of lines in the image frame and N represents the number of pixels within each line. The M×N pixel block, which is utilized in level 0 of the motion vector computation hierarchy, may represent a full pixel image frame.

The sub-sample 2×2 block 302 may comprise suitable logic, circuitry and/or code that may utilize a subsampling ratio of 2×2. The sub-sample 2×2 block 302 may receive an M×N pixel block and generate a level 1 subsampled image frame comprising a (½M)×(½N) pixel block. The level 1 subsampled image frame, which may be utilized in level 1 of the motion vector computation hierarchy, may represent a half pixel image frame.

The sub-sample 2×2 block 304 may comprise suitable logic, circuitry and/or code that may utilize a subsampling ratio of 2×2, which when combined with the sub-sample 2×2 block 302 may create an effective subsampling ratio of 4×4. The sub-sample 2×2 block 304 may receive a (½M)×(½N) pixel block and generate a level 2 subsampled image frame comprising a (¼M)×(¼N) pixel block. The level 2 subsampled image frame, which may be utilized in level 2 of the motion vector computation hierarchy, may represent a quarter pixel image frame.

The quarter pixel block 306 may comprise suitable logic, circuitry and/or code that may enable computation of motion vectors based on a current quarter pixel image frame and a preceding quarter pixel image frame. In various embodiments of the invention, the motion vectors computed by the quarter pixel block 306 may utilize quarter pixel resolution. A pixel neighborhood, comprising a pixel block (where the pixel block is smaller than the image frame size), at a selected location within the preceding quarter pixel image frame may be selected as a level 2 preceding image processing block. A plurality of motion vectors may be computed by computing a correlation value between the level 2 preceding image processing block and each pixel block within a specified level 2 pixel motion vector search area within a current quarter pixel image frame. The pixel locations within the specified level 2 current pixel motion vector search area may correspond to the set of pixel locations within the preceding quarter pixel image frame from which the level 2 preceding image processing block is selected. The quarter pixel block 306 may utilize an interpolation filter to enable the computation of level 2 motion vectors at subpixel accuracy. The quarter pixel block 306 may enable the generation of interpolated pixel locations within each pixel block in the current and preceding quarter pixel image frames. This increases the number of pixel locations within each of the post-interpolation quarter pixel image frames and thereby enables the computation of level 2 motion vectors at subpixel accuracy. A maximum correlation value may indicate a location of a level 2 current image processing block within the current quarter pixel image frame, which corresponds to the level 2 preceding image processing block. In an exemplary embodiment of the invention, a level 2 motion vector may be computed based on the location of the level 2 preceding image processing block and the corresponding level 2 current image processing block.

The half pixel block 308 may comprise suitable logic, circuitry and/or code that may enable computation of level 1 motion vectors based on a current half pixel image frame, a preceding half pixel image frame and one or more computed level 2 motion vectors. In various embodiments of the invention, the level 1 motion vectors computed by the half pixel block 308 may utilize half pixel resolution. In an exemplary embodiment of the invention a pixel neighborhood, comprising a pixel block at a selected location within the preceding half pixel image frame may be selected as a level 1 preceding image processing block. The center location for the selected level 1 preceding image processing block may be determined based on a level 2 motion vector, which was computed as described above. In addition, a level 1 current pixel motion vector search area may be selected within the current half pixel image frame. The center location for the selected level 1 current pixel motion vector search area may be determined based on the computed level 2 motion vector.

A plurality of level 1 motion vectors may be computed by computing a correlation value between the level 1 preceding image processing block and each pixel block within the level 1 current pixel motion vector search area. The half pixel block 308 may utilize an interpolation filter to enable the computation of level 1 motion vectors at subpixel accuracy. The half pixel block 308 may enable the generation of interpolated pixel locations in the level 1 preceding image processing block and in the level 1 current pixel motion vector search area. This increases the number of pixel locations within the post-interpolation level 1 preceding image processing block and the post-interpolation level 1 current pixel motion vector search area and thereby enables the computation of level 1 motion vectors at subpixel accuracy.

The full pixel block 310 may comprise suitable logic, circuitry and/or code that may enable computation of level 0 motion vectors based on a current full pixel image frame, a preceding full pixel image frame and one or more computed level 1 motion vectors. In various embodiments of the invention, the level 0 motion vectors computed by the full pixel block 310 may utilize full pixel resolution. In an exemplary embodiment of the invention a pixel neighborhood, comprising a pixel block at a selected location within the preceding full pixel image frame may be selected as a level 0 preceding image processing block. The center location for the selected level 0 preceding image processing block may be determined based on a level 1 motion vector, which was computed as described above. In addition, a level 0 current pixel motion vector search area may be selected within the current full pixel image frame. The center location for the selected level 0 current pixel motion vector search area may be determined based on the computed level 1 motion vector.

A plurality of level 0 motion vectors may be computed by computing a correlation value between the level 0 preceding image processing block and each pixel block within the level 0 current pixel motion vector search area. The full pixel block 310 may utilize an interpolation filter to enable the computation of level 0 motion vectors at subpixel accuracy. The full pixel block 310 may enable the generation of interpolated pixel locations in the level 0 preceding image processing block and in the level 0 current pixel motion vector search area. This increases the number of pixel locations within the post-interpolation level 0 preceding image processing block and the post-interpolation level 0 current pixel motion vector search area and thereby enables the computation of level 0 motion vectors at subpixel accuracy.

The full pixel block 310 may output a set of computed level 0 motion vectors 220. In various embodiments of the invention, the set of computed level 0 motion vectors 220 may be utilized to enable generation of an interpolated image frame, which may be temporally located between the preceding image frame and the current image frame. The computed level 0 motion vectors 220 may enable computation of the interpolated image frame based on the full pixel resolution level.

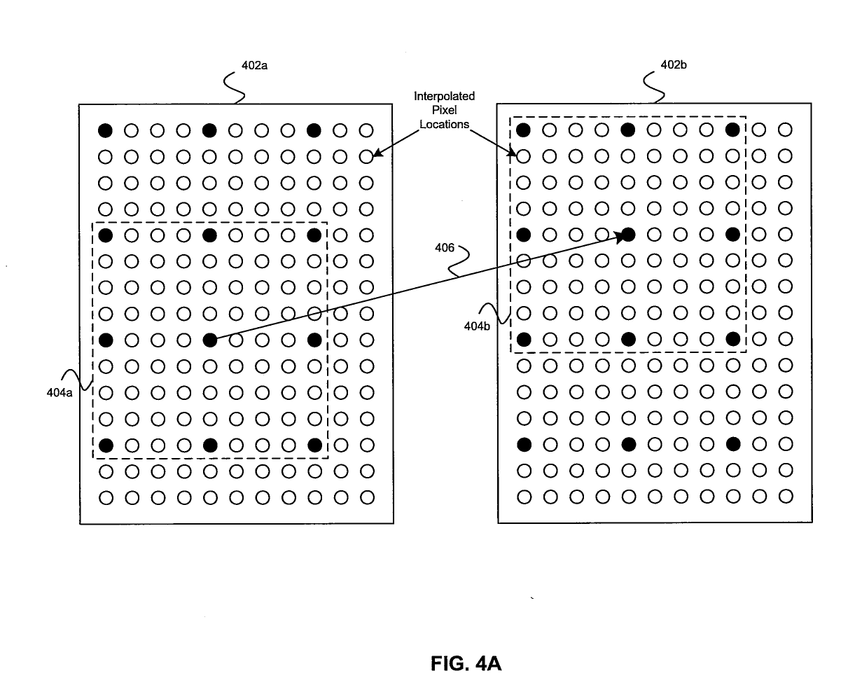

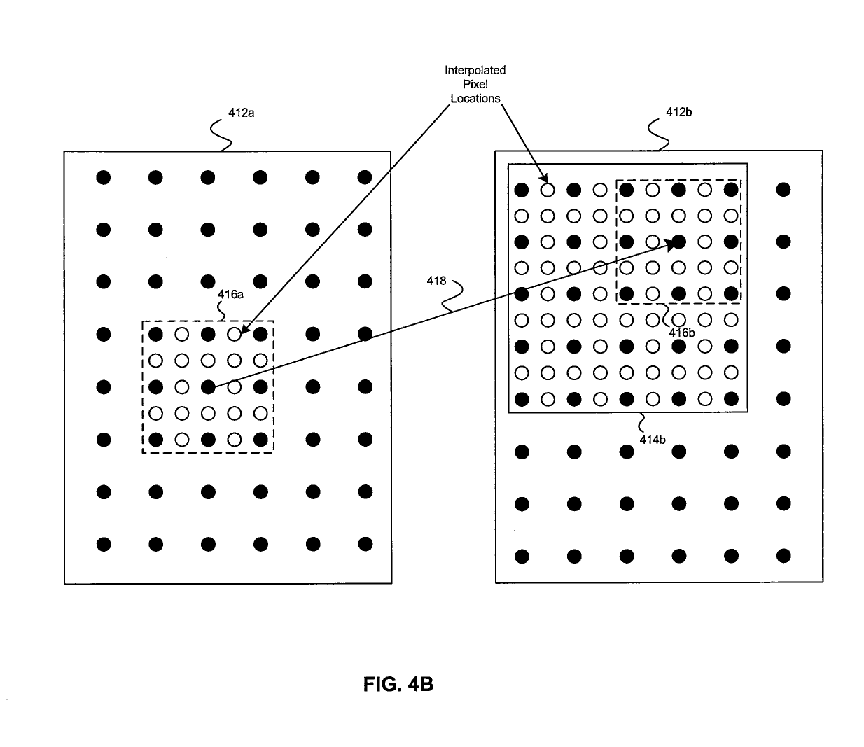

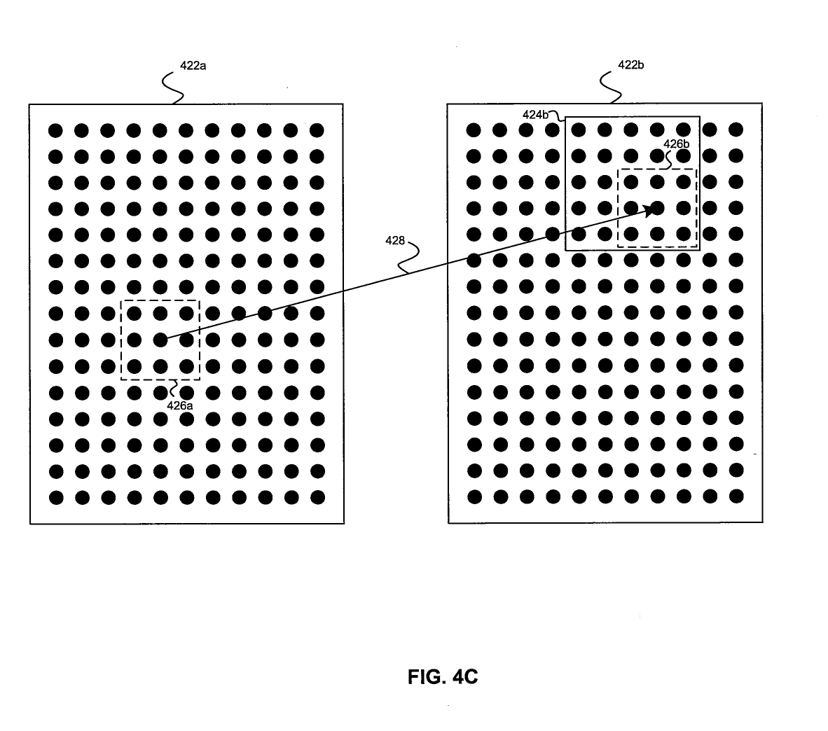

FIGS. 4 present exemplary illustrations of hierarchical motion estimation with multi-layer sub-pixel accuracy, which may be utilized in connection with an embodiment of the invention. FIG. 4A is a diagram that illustrates exemplary level 2 motion estimation, which may be utilized in connection with an embodiment of the invention. Referring to FIG. 4A, there is shown a preceding level 2 pixel motion vector search area within a preceding quarter pixel image frame 402a and current level 2 pixel motion vector search area within a current quarter pixel image frame 402b. A level 2 preceding image processing block 404a may be selected within the preceding level 2 pixel motion vector search area 402a. A corresponding level 2 current image processing block 404b may be selected based on a correlation value computation between the level 2 preceding image processing block 404a and each pixel block within the current level 2 pixel motion vector search area 402b. The quarter pixel block 306 may compute a level 2 motion vector 406 based on the image processing blocks 404a and 404b. The level 2 motion vector 406 may be computed at the quarter pixel resolution level. The quarter pixel block 306 may utilize an interpolation filter to generate interpolated pixel locations within the motion vector search areas 402a and 402b. The interpolated pixel locations may enable the quarter pixel block 306 to compute the motion vector 406 at a subpixel level of accuracy.

FIG. 4B is a diagram that illustrates exemplary level 1 motion estimation, which may be utilized in connection with an embodiment of the invention. Referring to FIG. 4B, there is shown a preceding half pixel image frame 412a and a current half pixel image frame 412b. A level 1 preceding image processing block 416a may be selected within the preceding half pixel image frame 412a. The location of the level 1 preceding image processing block 416a may be determined based on the level 2 motion vector 406 (FIG. 4A). A level 1 current pixel motion vector search area 414b may be selected within the current half pixel image frame 412b. The location of the pixel motion vector search area 414b may be determined based on the level 2 motion vector 406. A level 1 current image processing block 416b may be selected based on a correlation value computation between the level 1 preceding image processing block 416a and each pixel block within the level 1 current pixel motion vector search area 414b. A level 1 motion vector 418 may be computed based on the image processing blocks 416a and 416b. The level 1 motion vector 418 may be computed at the half pixel resolution level. The half pixel block 308 may utilize an interpolation filter to generate interpolated pixel locations within the image processing block 416a and within the motion vector search area 414b. The interpolated pixel locations may enable the quarter pixel block 306 to compute the motion vector 418 at a subpixel level of accuracy.

FIG. 4C is a diagram that illustrates exemplary level 0 motion estimation, which may be utilized in connection with an embodiment of the invention. Referring to FIG. 4C, there is shown a preceding full pixel image frame 422a and a current full pixel image frame 422b. A level 0 preceding image processing block 426a may be selected within the preceding half pixel image frame 422a. The location of the level 0 preceding image processing block 426a may be determined based on the level 1 motion vector 418 (FIG. 4B). A level 0 current pixel motion vector search area 424b may be selected within the current full pixel image frame 422b. The location of the pixel motion vector search area 424b may be determined based on the level 1 motion vector 418. A level 0 current image processing block 426b may be selected based on a correlation value computation between the level 0 preceding image processing block 426a and each pixel block within the level 0 current pixel motion vector search area 424b. A level 0 motion vector 428 may be computed based on the image processing blocks 426a and 426b. The level 0 motion vector 428 may be computed at the full pixel resolution level.

Various embodiments of the invention may be practiced with differing numbers of levels in the motion vector computing hierarchy. For example, an exemplary embodiment of the invention may utilize more or less than three (3) levels in the motion vector computing hierarchy. Various embodiments of the invention may be practiced with differing subsampling ratios and/or interpolation ratios. The subsampling ratios may be determined independently from the interpolation ratios and vice versa. Subsampling ratios may be selected independently for each level in the motion vector computing hierarchy. Interpolation ratios may be selected independently for each level in the motion vector computing hierarchy. Various embodiments of the invention may be practiced with preceding and current image frames of varying sizes, with motion vector search areas of varying pixel neighborhood sizes and/or with preceding and current image processing blocks of varying pixel neighborhood sizes. For example, an exemplary embodiment of the invention may utilize 3×3, 5×5 or 9×9 pixel neighborhood sizes for preceding and current image processing blocks. Various embodiments of the invention may be practiced with the roles of the preceding and current images reversed such that motion vectors may be found in both the forward and backward temporal directions.

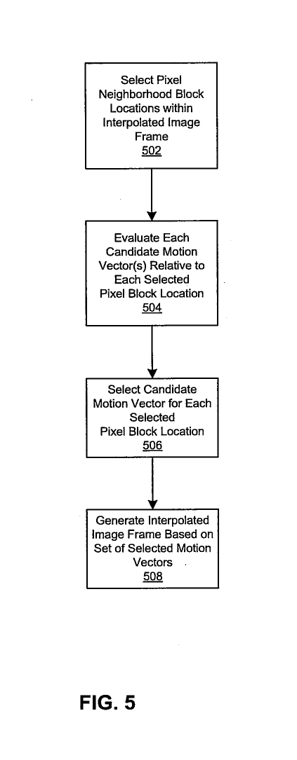

FIG. 5 is a flowchart illustrating exemplary steps for motion vector estimation using a pivotal pixel search, in accordance with an embodiment of the invention. Referring to FIG. 5, in step 502, a plurality of pixel neighborhood block locations may be selected within an interpolated image frame. The plurality of pixel neighborhood block locations may define a plurality of P×Q pixel neighborhoods such that each pixel within the within the interpolated image frame is contained in a single one of the plurality of P×Q pixel neighborhoods. In step 504, each of a plurality of candidate motion vectors 220 may be evaluated relative to each pixel block location selected in step 502. In an exemplary embodiment of the invention, for each selected pixel block location within the interpolated image frame a set of candidate vectors, which intersect in the vicinity of a pivot pixel location within the selected pixel block location may be selected. A correlation error value may be computed for each of the candidate motion vectors. In step 506, a candidate motion vector may be selected for each selected pixel block location. In an exemplary motion vector selection criterion, a motion vector selected for a given pixel block location within the interpolated image frame may correspond to a minimum computed correlation error value among the set of candidate motion vectors. In step 508, an interpolated image frame may be generated base on the selected motion vectors. In various embodiments of the invention, corresponding image processing blocks may be located within a preceding image frame and a current image frame based on each selected motion vector. Pixel values within each pixel block location within the interpolated image frame may be generated based on the corresponding image processing blocks within the preceding and current image frames. In a hierarchical motion estimation system, in which motion vectors may be computed at various levels of pixel resolution, the pivotal pixel search method may be utilized in one or more levels within the motion vector computation hierarchy.

Aspects of a method and system for motion vector estimation using a pivotal pixel search may comprise an image interpolation system 202 that enables selection of an interpolated picture element neighborhood 106 within an interpolated image frame 102c. The image interpolation system 202 may enable selection of one of a plurality of computed candidate motion vectors 112a, 112b, 112c, 112d and 112e based on the location of the interpolated picture element neighborhood 106 the interpolated image frame 102c. The location of the interpolated picture element neighborhood 106 may be coincident with the center of the interpolated picture element neighborhood 106. The image interpolation system 202 may enable generation of picture element values within the selected interpolated picture element neighborhood 106 based on at least the selected one of the plurality of computed candidate motion vectors 112c.

The interpolated image frame 106 may be temporally located between a preceding image frame 102a and a current image frame 102b. A full pixel block 310 enable generation of the plurality of computed candidate motion vectors 112a, 112b, 112c, 112d and 112e based on the preceding image frame 102a and the current image frame 102b. The image interpolation system 202 may enable selection of one or both of: a preceding picture element neighborhood 104a within the preceding image frame 102a and a current picture element neighborhood 104d within the current image frame 102b. The full pixel block 310 may enable computation of the selected one 112c of the plurality of computed motion vectors 112a, 112b, 112c, 112d and 112e based on the selected preceding picture element neighborhood 104a and the selected current picture element neighborhood 104d. The image interpolation system may enable generation of the picture element values within the selected interpolated picture element neighborhood 106 based on the selected preceding picture element neighborhood 104a and/or the selected current picture element neighborhood 104d.

The plurality of computed candidate motion vectors 112a, 112b, 112c, 112d and 112e may intersect in the vicinity of a selected pixel location 108 within the interpolated image frame 106. The selected pixel location 108 may correspond to a pivot pixel location. The image interpolation system 202 may enable computation of a correlation error value for each of the plurality of computed candidate motion vectors. The image interpolation system 202 may enable determination of a minimum value among the computed plurality of correlation error values. The selected one 112c of the plurality of computed candidate motion vectors may correspond to the determined minimum correlation error value.

In various embodiments of the invention, the plurality of candidate motion vectors 112a, 112b, 112c, 112d and 112e may be generated by the half pixel block 308, for example. The selected motion vector 112c may be utilized by the full pixel block 310 to generate one or more subsequent motion vectors. At least one of the subsequent motion vectors may be utilized by the image interpolation system 202 to enable generation of the picture element values within the selected interpolated picture element neighborhood 106.

Another embodiment of the invention may provide a machine-readable storage having stored thereon, a computer program having at least one code section executable by a machine, thereby causing the machine to perform steps as described herein for motion vector estimation using a pivotal pixel search.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for image processing, the system comprising:
one or more circuits that enable selection of an interpolated picture element neighborhood within an interpolated image frame;
said one or more circuits enable selection of one of a plurality of computed candidate motion vectors based on a location of said interpolated picture element neighborhood within said interpolated image frame; and
said one or more circuits enable generation of picture element values within said selected interpolated picture element neighborhood based on at least said selected one of said plurality of computed candidate motion vectors.

2. The system according to claim 1, wherein said interpolated image frame is temporally located between a preceding image frame and a current image frame.

3. The system according to claim 2, wherein said one or more circuits enable generation of said plurality of computed candidate motion vectors based on said preceding image frame and said current image frame.

4. The system according to claim 2, wherein said one or more circuits enable selection of one or both of: a preceding picture element neighborhood within said preceding image frame and a current picture element neighborhood within said current image frame.

5. The system according to claim 4, wherein said one or more circuits enable computation of said selected one of said plurality of computed motion vectors based on said selected preceding picture element neighborhood and said selected current picture element neighborhood.

6. The system according to claim 4, wherein said one or more circuits enable generation of said picture element values within said selected interpolated picture element neighborhood based on one or both of: said selected preceding picture element neighborhood and said selected current picture element neighborhood.

7. The system according to claim 1, wherein said plurality of computed candidate motion vectors intersect in the vicinity of a selected pixel location within said interpolated image frame.

8. The system according to claim 7, wherein said one or more circuits enable computation of a correlation error value for each of said plurality of computed candidate motion vectors.

9. The system according to claim 8, wherein said one or more circuits enable determination of a minimum value among said computed plurality of correlation error values.

10. The system according to claim 9, wherein said one or more circuits enable selection of said one of said plurality of candidate motion vectors based on said determined minimum value.

11. The system according to claim 1, wherein said one or more circuits enable generation of one or more subsequent computed candidate motion vectors based on said selected one of said plurality of computed candidate motion vectors.

12. The system according to claim 11, wherein said one or more circuits enable generation of said picture element values within said selected interpolated picture element neighborhood based on at least one of said one or more subsequent computed candidate motion vectors.

13. A method for image processing, the method comprising:
selecting an interpolated picture element neighborhood within an interpolated image frame;
selecting one of a plurality of computed candidate motion vectors based on a location of said interpolated picture element neighborhood within said interpolated image frame; and
generating picture element values within said selected interpolated picture element neighborhood based on at least said selected one of said plurality of computed candidate motion vectors.

14. The method according to claim 13, wherein said interpolated image frame is temporally located between a preceding image frame and a current image frame.

15. The method according to claim 14, comprising generating said plurality of computed candidate motion vectors based on said preceding image frame and said current image frame.

16. The method according to claim 14, comprising selecting one or both of: a preceding picture element neighborhood within said preceding image frame and a current picture element neighborhood within said current image frame.

17. The method according to claim 16, comprising computing said selected one of said plurality of computed motion vectors based on said selected preceding picture element neighborhood and said selected current picture element neighborhood.

18. The method according to claim 16, comprising generating said picture element values within said selected interpolated picture element neighborhood based on one or both of: said selected preceding picture element neighborhood and said selected current picture element neighborhood.

19. The method according to claim 13, wherein said plurality of computed candidate motion vectors intersect in the vicinity of a selected pixel location within said interpolated image frame.

20. The method according to claim 19, comprising computing a correlation error value for each of said plurality of computed candidate motion vectors.

21. The method according to claim 20, comprising determining a minimum value among said computed plurality of correlation error values.

22. The method according to claim 21, comprising selecting one of said plurality of candidate motion vectors based on said determined minimum value.

23. The method according to claim 13, comprising generating one or more subsequent computed candidate motion vectors based on said selected one of said plurality of computed candidate motion vectors.

24. The method according to claim 23, comprising generating said picture element values within said selected interpolated picture element neighborhood based on at least one of said one or more subsequent computed candidate motion vectors.
